(19) United States
(12) Patent Application Publication
(10) Pub. No.: US 2013/0064949 A1
(43) Pub. Date: Mar. 14, 2013

(54) Spray Nozzle Application to Transfer Flavoring Liquid onto Dry Animal Food

(71) Applicant: Mark Todd Vanselous, Colts Neck, NJ (US)

(72) Inventor: Mark Todd Vanselous, Colts Neck, NJ (US)

(21) Appl. No.: 13/229,677

(22) Filed: Sep. 10, 2011

(51) Int. Cl. A23K 1/18

(52) U.S. Cl. 426/442

(57) ABSTRACT

The application of a spray nozzle to delivery flavoring onto dry animal food for the purpose of making the dry food taste better so the animal is more likely to consume. Currently canned, bagged, gravy and leftover foods are used for this purpose, but are messy, smell and require mixing. The invention provides a better and more user friendly way for the animal owner, veterinarian or general to improve the flavor of dry animal food so the animal will consume with no mess, smell or mixing requirements.

### CROSS-REFERENCE TO RELATED APPLICATION

Nothing came up during search.

### STATEMENT REGARDING FEDERALLY SPONSORED RESEARCH AND DEVELOPMENT

Not applicable

### REFERENCE OF SEQUENCE LISTING, A TABLE, OR A COMPUTER LISTING COMPACT APPENDIX

Not applicable

### BACKGROUND OF THE INVENTION

In many cases, we add canned of wet food or other additives to dry nugget animal food in order to help improve the taste so our animals will eat the healthy dry animal food. We have to open a can or bag of wet food or leftovers, grab a spoon, scoop a portion out, mix in, than cover and store the remaining product in the refrigerator or throw out the container and smell it in the garbage. This can be messy and time consuming along with the unpleasant smell of the wet or canned food.

### BRIEF SUMMARY OF THE INVENTION

A person can use a spray nozzle application to transfer liquid flavoring on to dry animal food for the purpose of getting the animal to eat the dry food. The nozzle application removes the mess as it is applied and directed via the spray nozzle. The unpleasant smell factor during storage is no longer present as the liquid flavoring is contained by the spray nozzle. Further, no after mixing is require as the spray nozzle evenly distributes the flavoring onto the dry animal food.

### BRIEF DESCRIPTION OF THE SEVERAL VIEWS OF THE DRAWINGS

Not Applicable

### DETAILED DESCRIPTION OF THE INVENTION

Many pet owners, veterinarians, and the general population will add some food flavor additive to dry animal food to influence the animal to positively eat the healthy dry animal food. A variety of foods are added to dry animal food: canned, bagged, bottled, leftovers etc. In all cases they are messy, should be mixed into to dry food for even distribution and can have an unpleasant smell. Once again this is all to get the animal to eat the healthy dry animal food.

The invention is a replacement for the current food additives on the market. The spray nozzle application to transfer flavor liquid onto dry animal food solves the problems mentioned above. No mess: The spray nozzle is controlled and will spray where you point it. Will not leave a mess in the bowl or on you animals face after eating. No mixing: the spray evenly distributes the flavoring though out the dry food. No smell: after each application as the liquid is contained and capped by the spray nozzle.

A flavoring liquid such as, but not limited to flavors such as cheese, meat, fish, bacon, steak, etc were developed and placed in a container/bottle and capped with a spray nozzle (In our testing we used 1 to 12 oz poly cylinder bottles). The spray nozzle was pointed at a bowl of dry animal food and the spray nozzle was compressed such that a portion of the flavoring liquid was transferred from the bottle via a spray mist onto the dry animal food. This procedure was repeated until the desired amount of flavoring was transferred from the bottle onto the dry animal food (In our testing 4 sprays).

The invention provides a better more user friendly way for the consumer to improve the flavor of dry animal food.

### DRAWINGS

Not applicable

### OATH OR DECLARATION

See Form PTO/SB/05

### SEQUENCE LISTING

Not Applicable

1. Spray nozzle application to transfer flavoring liquid onto dry animal food.

2. Spray flavoring onto dry animal food.

3. Use a spray nozzle to deliver flavoring to dry animal food.
